(19) United States
(12) Patent Application Publication
(10) Pub. No.: US 2008/0112686 A1
(43) Pub. Date: May 15, 2008

(54) Automatic Completion of Media Recording

(76) Inventors: Yen-Fu Chen, Austin, TX (US); Blaine H. Dolph, Western Springs, IL (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/558,033

(22) Filed: Nov. 9, 2006

(51) Int. Cl. H04N 5/91

(52) U.S. Cl. 386/83

(57) ABSTRACT

A method and system are provided in which metadata associated with programs selected to be recorded are monitored in real time and the recording begins and ends when the selected title is detected from actual video header information regardless of the time slot within which the program is scheduled to run. Another feature enables the recording of a designated program beyond its assigned time slot even when there is insufficient storage space on the user's DVR or other storage device. Other interconnected DVR or other storage devices are accessed to record one or more portions of the selected program. When a user desires a playback of the recording, the recorded program is played-back from the various networked multiple storage resources, each of which may contain one or more portions of the recorded program.

### FIELD OF THE INVENTION

The present invention relates generally to recording systems and more particularly to a system and methodology for enabling recording of programs which continue beyond assigned time slots.

### BACKGROUND OF THE INVENTION

Digital Recording of multi-media programs has become relatively common. The typical manner to have the Digital Video Recorder (DVR) record selected programs is to set up a list of programs to be recorded from a program guide. The DVR is then responsible for reading its internal programming guide and recording the program from the start time to the end time that is associated or assigned with each program. At the end of the assigned time slot for the program being recorded, the DVR stops recording the program even though, in many cases, especially sporting events and other live or interrupted events, the program may continue beyond its assigned time slot. In such cases, the ending of the program is not recorded and the viewer will miss the end of the program when it is replayed.

Thus, there is a need for an improved system and methodology for enabling a user to continue to record a designated program even when that program runs-over its assigned time slot.

### SUMMARY OF THE INVENTION

A method and system are provided in which metadata associated with programs selected to be recorded are monitored in real time and the recording begins and ends when the selected title is detected from actual video header information regardless of the time slot within which the program is scheduled to run. In one embodiment, the recording of the program begins when a selected title has been detected and continues until it is detected that the program has actually ended, and the header title information has changed, regardless of the scheduled ending time or time slot within which the program is scheduled to be played. Another feature enables the recording of a designated program beyond its assigned time slot even when there is insufficient storage space on the user's DVR or other storage device. If one DVR, for example, is unable to perform the continued recording of a selected program beyond the program's assigned time slot, other interconnected DVR devices are accessed to record one or more portions of the selected program. When a user desires a playback of the recording, the recorded program is played-back from the various networked multiple storage resources, each of which may contain one or more portions of the recorded program.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing an exemplary display device coupled to a digital video recorder (DVR) control unit;

FIG. 2 is a schematic block diagram showing several of the major components of a DVR control unit in an exemplary implementation of the present invention;

FIG. 3 is an illustration of an exemplary program guide useful in explaining an operation of the present invention;

FIG. 4 is a flow chart illustrating an exemplary operation of the present invention;

FIG. 5 is an illustration of several DRV units connected in a networked configuration;

FIG. 6 is a flow chart illustrating an exemplary sequence for finding storage space in networked DVR units;

FIG. 7 shows an exemplary database which may be used in connection with the present invention;

FIG. 8 is a flow chart illustrating an exemplary sequence of operations in assembling portions of a recorded program from multiple control unit memory locations; and

FIG. 9 is a continuation of FIG. 8.

### DETAILED DESCRIPTION

It is noted that devices which are shown in block or schematic form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

There is herein presented, an automated way of recording the completion of programs which start early or late or run-past their assigned time slot using a small module/program that interrogates the cable/broadcast frame marker (or meta-tag). In an example, the meta-tag title of a program is stored and the recording of that program will begin when a selected title is detected, and continue until a new title is detected for the currently presented program. When a program over-runs its assigned time slot, the over-run portion is automatically stored in a buffer which will automatically be accessed and appended when the recorded program is played back by a user.

Each digital broadcast contains header information about the program that is being delivered to the user via a control unit or “set-top box”. The header contains various information about the program—such as title, content provider, frame marker and flags for enabling Digital Rights Management. The recorder will record the scheduled program until it receives the new header information for the next program. This means that the recording length will no longer be determined by the program guide, but rather will record exactly the length of the program. This allows one to record a show to the exact length that the show is presented even if the show runs over its allotted time slot.

In addition, an exemplary embodiment allows for one DVR device to coordinate recording jobs with other DVR devices in a user's network. Thus, a user will be able initially to attempt to schedule the recording of TV shows on a first DVR device. If the show runs over its assigned time slot, and there is no storage space available on the user's control unit or DVR, then the first DVR device will then interact with other DVRs in the user's network. If another DVR device in the network has sufficient storage space available to record the over-run, then the job of recording the over-run portion of the program being recorded will be delegated to the second DVR device. To the end user, recorded TV shows will appear as if the recorded TV shows were recorded on the DVR with which the user is interfacing.

Although DVRs are implemented in the exemplary embodiments presented herein, it is understood that the present invention is not limited to DVRs and is also applicable to other multimedia applications for recording and transmitting video presentations. Further, the following description focuses upon the continued recording of programs that over-run their time slot but it is understood that the header information sensing process applies equally well to determine when a selected program recording begins in the case where the beginning of a program selected for recording either begins ahead of its scheduled start time or later than its scheduled time slot. In either case, the recording, both the beginning and the ending, will be controlled by the detection of header metadata information rather than by the scheduled start and stop times as shown in the video program guide.

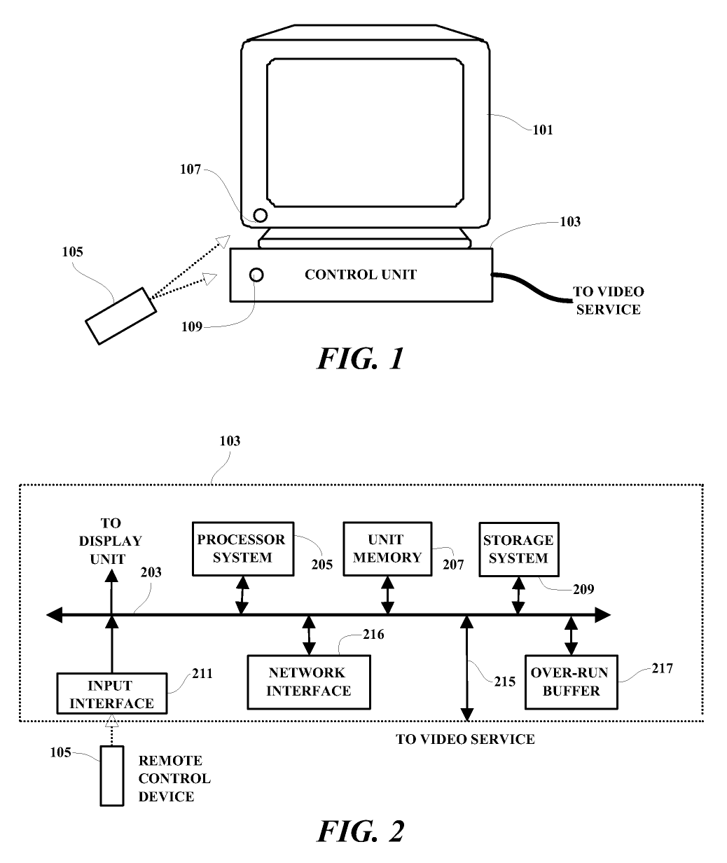

FIG. 1 shows a display device 101 which is coupled to a control unit or DVR 103 which is in turn coupled to a video service provider. A remote control device 105 is operable to communicate with the control unit IR port 109 and a display unit IR port 107 to input user commands to the control unit 103 and display device 101. Typically, shows are presented on the display device 101 from the video service provider and the user is enabled, by using the remote control unit 105, to select which shows are displayed and/or recorded.

FIG. 2 shows several of the major components of an exemplary DVR control unit 103. The control unit 103 includes a main bus 203 to which is connected a processor system 205, a unit memory 207, a storage system 209, an input interface 211 and a network interface 216. As discussed above, the network interface 216 may be connected only to a local network such as the network internal to a building, and may also be connected to an external network. The main bus 203 is also coupled 215 to a video or cable service. The input interface 211 also includes, for example, an infrared function for communicating with a hand-held remote control unit 105 through which a user is enabled to select programs to be recorded and played on the display device 101. Also shown is a buffer unit 217 connected to the main bus 203. The buffer is arranged to receive and store portions of programs being recorded when such programs continue beyond their allotted tome slot. A mapping is maintained for the over-flow portions and at playback time, the main program and the continued portions are accessed from their respective storage addresses and seamlessly played back to the user so that the user is able to view programs that extended beyond their designated scheduled time slot.

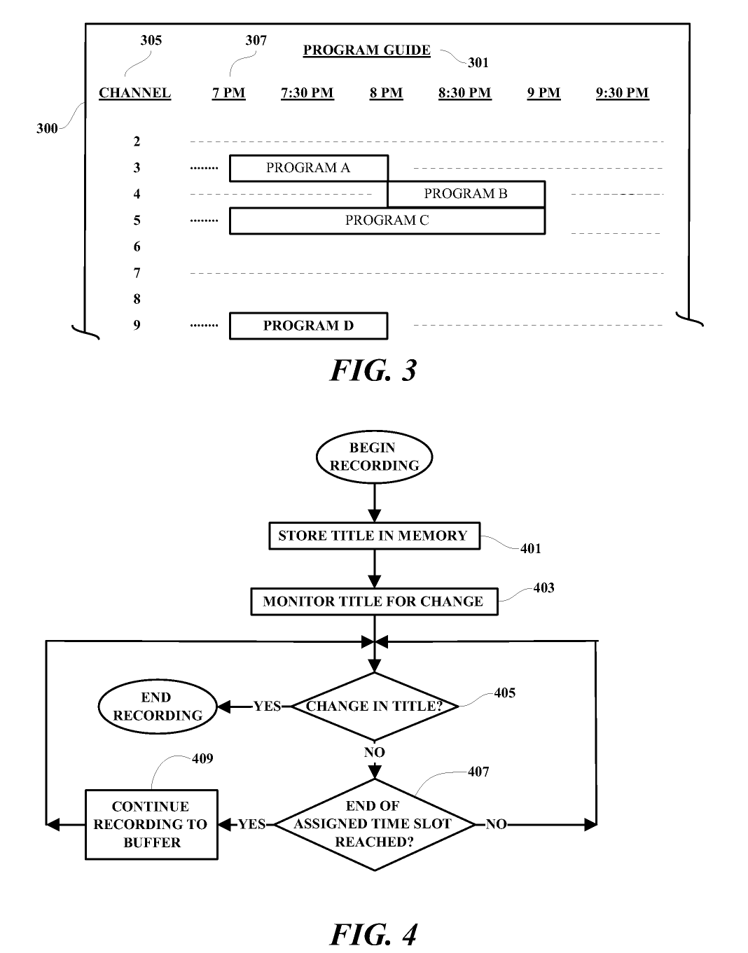

FIG. 3 illustrates an exemplary Program Guide 301 which is selectively displayed to a user on a display screen 303 of a monitor or display device 101. The Program Guide 301 includes, in a first column 305, the various channels which may be selected by the user. Also shown are various time slots 307 during which various programs are scheduled to be presented. The user is enabled to control the selection of certain ones of the programs through the use of the remote control device 105. In an exemplary operation, it is presumed that the user wishes to schedule a recording of Program D from the user's control unit. The user will highlight Program D on the Program Guide and push a “Record” button (not shown) on the remote control unit 105. Typically, this action will effect a recording of whatever is played on channel 9 between 7 PM and 8 PM. However, with the present invention, if program D is, for example a baseball game that goes extra innings, the recording will continue to record past the designated 8 PM end time until the program has actually ended as determined by the detection of a change in a designated metadata indicium, for example, when the title changes from “Major League Baseball Game” to “Highlight Show”.

FIG. 4 illustrates an exemplary functional sequence of an operation of the present invention. As shown, when a DVR begins recording a selected program, the title or other metadata indicium uniquely identifying the program is stored in memory 401. The indicium, for example the title, is then monitored 403 and when there is a change detected in the title 405, the recording is ended regardless of the particular time at which the program ends. While there is no change in the monitored indicium e.g. title, the program will continue to be recorded 409 even though the end of the assigned time slot may have been reached 407.

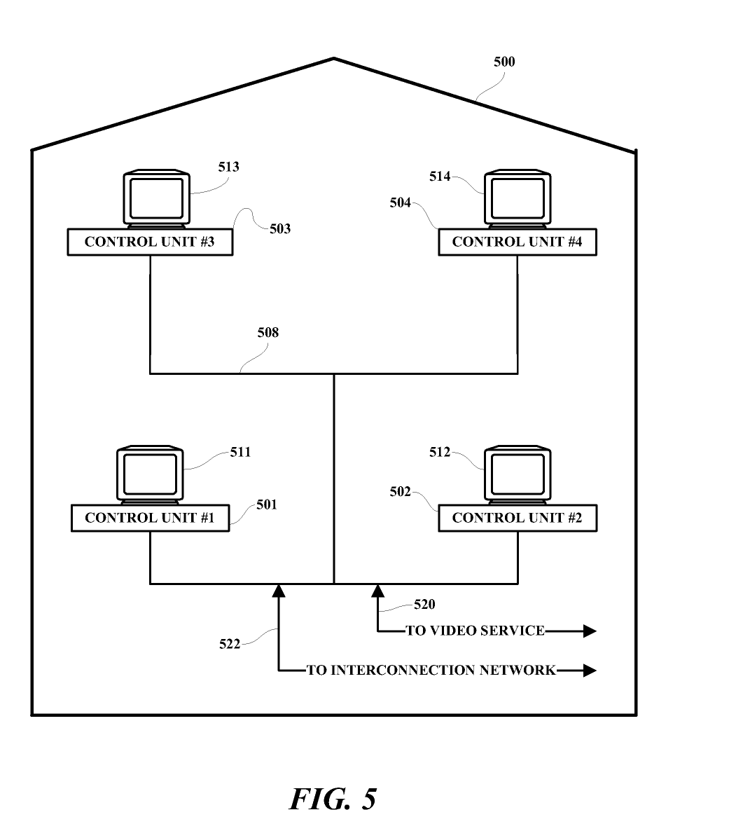

In FIG. 5, there is shown a building structure 500 which may be an office building or a user's home. The building 500 includes a local interconnection network 508 which is arranged to interconnect several monitor/DVR control unit stations. As illustrated in the example, four DVR control units 501, 502, 503 and 504 are interconnected through the local interconnection network 508. Each of the DVR control units 501-504 is coupled to and controls a corresponding video monitor or display device 511, 512, 513 and 514, respectively. The control units 501-504 are connected together and also to an external connection 520 to a video service such as a cable service company. The control units 501-504 may also be connected through another external connection 522 to an external interconnection network such as the Internet for ultimate connection to remote servers and web sites. Thus, as illustrated, the DVR devices within the building 500 are connected together and may also be connected to external control units (not shown) at other locations through an Internet connection 522.

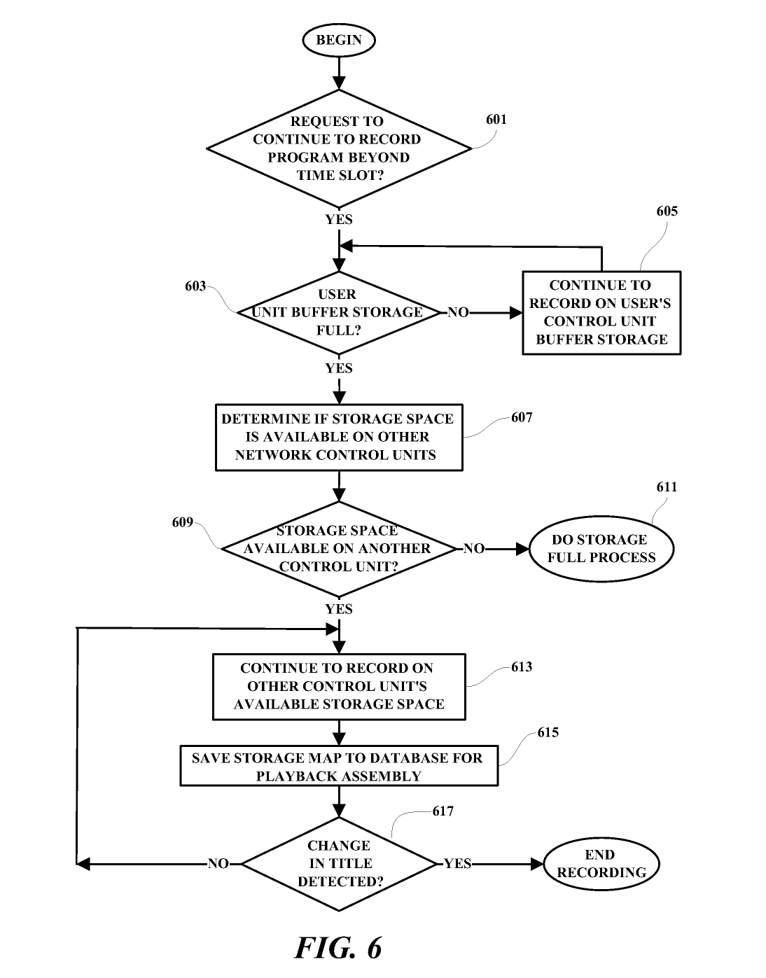

As shown in FIG. 6, when a program being recorded runs beyond its allotted time slot, the DVR will continue to record the program 601. If the user unit's buffer storage is not full 603 the continuation of the recording of the program will be stored directly into the buffer 605 of the user's control unit. If however, the user's buffer is full and there in no available storage space 603, then the system determines if storage space is available on another networked control unit 607, and if so, the recording is continued and stored on that unit 613. A record is maintained and stored of where the various recorded portions are stored for playback assembly 615 when the user wishes to playback the recorded program in its entirety. The recording process will be continued until the monitored indicium such as the title of the program changes 617. If it is determined that there are no other control units available for storing the over-run portion of the recorded program 609, then a storage-full process is initiated 611 in which the oldest recorded program, for example may be erased in order to create storage space for the over-run portion of the program currently being recorded. If necessary, the continuing program is temporarily stored in a small buffer while the additional storage space is created.

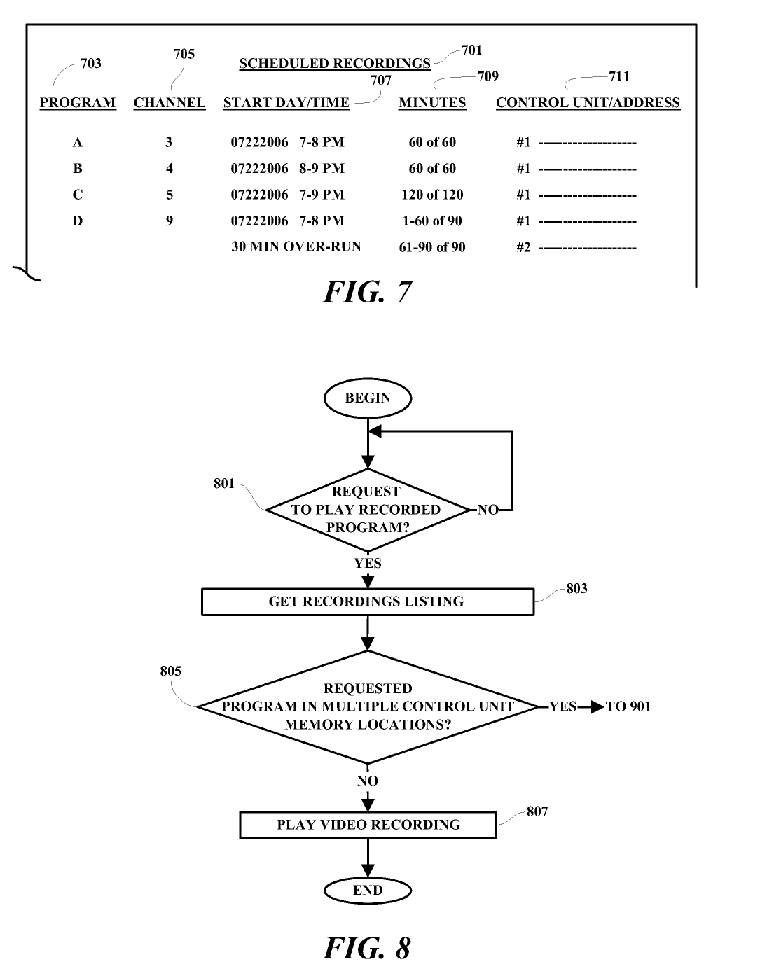

FIG. 7 illustrates an example of a Scheduled Recordings Listing 701 which may be used as a data base to track where, i.e. in which control units storage system, the various portions of a recorded program are located. The scheduled recordings listing is used to re-assemble recordings when portions of the recording are stored in different control unit's storage systems. The Listing 701 may include a program title 703, the channel 705 from which the program was recorded, a start day and time 707 and the number of minutes 709 in the portions recorded in the designated control units. For example, to playback recorded program D, (which was scheduled for 60 minutes but ran over to 90 minutes) the system would access the Listing 701 and determine that the first sixty minutes of the 90 minute recording will be accessed from an address within the #1 Control Unit and the 30 minute run-over portion will be accessed from an address within the #2 Control Unit.

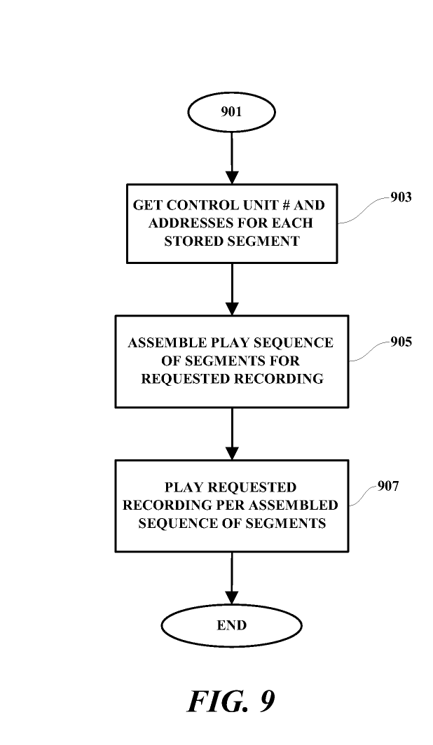

As shown in FIG. 8, when a playback is requested 801 by a user, the recorded programs listing 701 is accessed 803. If it is determined that multiple control unit's storage systems have been used to record the program 805 then the system continues to 901 in FIG. 9. If multiple control units were not used 805 to store the recorded program, then the requested program is played from the user's control unit storage system 807 and the processing is ended. If, however, the requested program has been stored in more than one network-connected control unit's storage system 805, then the processing continues 901 by accessing control unit numbers and addresses for each stored segment 903. The various segments are then assembled or listed for sequential access 905 and the entire recorded program is then played 907 at the display device and control unit from which the request for playback is being made.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other storage or memory device or array, from which it may be executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for controlling beginning and ending times of a recording of a program selected to be recorded, said method comprising:
monitoring a video data stream for program header information descriptive of said program; and
starting or stopping said recoding based upon detection of said program header information.

2. The method as set forth in claim 1 and further including enabling storage of portions of said recording at a plurality of storage devices as needed to store said recording in its entirety.

3. The method as set forth in claim 1 and further including:
monitoring a program indicium representative that said program is being transmitted, said program indicium being transmitted along with said program as long as said program continues to be transmitted; and
beginning or ending said recording of said program in response to a detected presence of said program indicium.

4. The method as set forth in claim 3 wherein said program indicium is an element of metadata information being transmitted in association with said program.

5. The method as set forth in claim 4 wherein said element comprises a title of said program.

6. The method as set forth in claim 1 wherein said storage devices are part of respective digital video recorder units, said digital video recorder units being interconnected together in a network configuration.

7. The method as set forth in claim 1 wherein said storage devices are located remotely from one another, said method further including enabling a playback of said recording by playing back said portions of said recording from said plurality of storage devices.

8. A medium containing machine-readable indicia, said machine-readable indicia being executable within a signal processing system for providing operational signals for controlling beginning and ending times of a recording of a program selected to be recorded, said operational signals being further effective for:
monitoring a video data stream for program header information descriptive of said program; and
starting or stopping said recoding based upon detection of said program header information.

9. The medium as set forth in claim 8 wherein said operational signals are further effective enabling storage of portions of said recording at a plurality of storage devices as needed to store said recording in its entirety.

10. The medium as set forth in claim 8 wherein said operational signals are further effective for:
monitoring a program indicium representative that said program is being transmitted, said program indicium being transmitted along with said program as long as said program continues to be transmitted; and
beginning or ending said recording of said program in response to a detected presence of said program indicium.

11. The medium as set forth in claim 10 wherein said program indicium is an element of metadata information being transmitted in association with said program.

12. The medium as set forth in claim 11 wherein said element comprises a title of said program.

13. The medium as set forth in claim 8 wherein said storage devices are part of respective digital video recorder units, said digital video recorder units being interconnected together in a network configuration.

14. The medium as set forth in claim 8 wherein said storage devices are located remotely from one another, said operational signals being further effective for enabling a playback of said recording by playing back said portions of said recording from said plurality of storage devices.

15. A system for controlling beginning and ending times of a recording of a program selected to be recorded, said system comprising:
means for monitoring a video data stream for program header information descriptive of said program; and
means for starting or stopping said recoding based upon detection of said program header information.

16. The system as set forth in claim 15 and further including means for enabling storage of portions of said recording at a plurality of storage devices as needed to store said recording in its entirety.

17. The system as set forth in claim 15 and further including:
means for monitoring a program indicium representative that said program is being transmitted, said program indicium being transmitted along with said program as long as said program continues to be transmitted; and
means for beginning or ending said recording of said program in response to a detected presence of said program indicium.

18. The system as set forth in claim 17 wherein said program indicium is an element of metadata information being transmitted in association with said program.

19. The system as set forth in claim 18 wherein said element comprises a title of said program.

20. The system as set forth in claim 15 wherein said storage devices are part of respective digital video recorder units, said digital video recorder units being interconnected together in a network configuration, said storage devices being located remotely from one another, said system being operable for enabling a playback of said recording by playing back said portions of said recording from said plurality of storage devices.
